(19) United States
(12) Patent Application Publication
(10) Pub. No.: US 2026/0019652 A1
(43) Pub. Date: Jan. 15, 2026

(54) DISTRIBUTION SYSTEM

(71) Applicant: Avex Technologies Inc., Minato-ku (JP)

(72) Inventors: Yutaka KINO, Minato-ku (JP); Kenichiro YONEKURA, Minato-ku (JP)

(21) Appl. No.: 18/880,116

(22) PCT Filed: Jun. 9, 2023
(86) PCT No.: PCT/JP2023/021585

§ 371 Date: Dec. 30, 2024

(30) Foreign Application Priority Data
Jun. 28, 2022 (JP) 2022-103727

(51) Int. Cl. H04N 21/2187; G06T 7/20; G06T 7/70; G06V 40/20; H04N 21/442; H04N 21/475

(52) U.S. Cl. CPC H04N 21/2187; G06T 7/20; G06T 7/70; G06V 40/20; H04N 21/44218; H04N 21/4758

(57) ABSTRACT

A distribution system comprising: a video distribution unit that distributes live video to a first viewer terminal of a first viewer who is watching the video online; and a service provision unit that accepts responses to the questionnaire from both the first viewer terminal and a second viewer terminal of a second viewer who is watching the live performance at a venue.

### TECHNICAL FIELD

This invention relates to a distribution system.

### BACKGROUND ART

Live performances are being distributed via communication networks (see Patent Literature 1).

### CITATION LIST

### Patent Literature

[PTL 1] Japanese Patent Application Publication No. 2012-203523

### SUMMARY OF INVENTION

### Technical Problem

There is a need to conduct a survey during a live performance.

The present invention was made in light of this background, and its purpose is to provide a technique that enables surveys to be conducted during live performances.

### Solution to Problem

The main invention for solving the above problem is a distribution system comprising: a video distribution unit that distributes live video to a first viewer terminal of a first viewer who is watching the video online; and a service provision unit that accepts responses to the questionnaire from both the first viewer terminal and a second viewer terminal of a second viewer who is watching the live performance at a venue.

Other issues disclosed in this application and their solutions will be clarified in the “Description of Embodiments” section and in the drawings.

### Advantageous Effects of Invention

According to this invention, surveys can be conducted during live performances.

### BRIEF DESCRIPTION OF DRAWINGS

FIG. 1 is a diagram showing an example of the overall configuration of the distribution system.

FIG. 2 is a diagram showing an example of the hardware configuration of distribution server 20.

FIG. 3 is a diagram showing an example of the software configuration of distribution server 20.

FIG. 4 is a diagram showing the operation of the distribution system.

### DESCRIPTION OF EMBODIMENTS

### <System Overview>

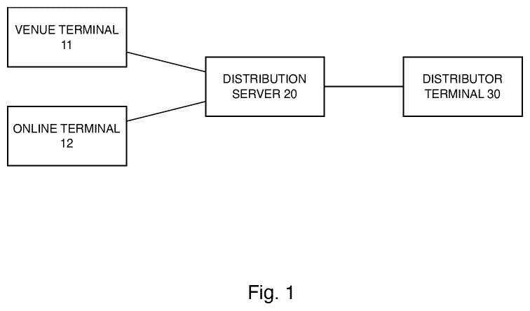

The following describes an embodiment of the distribution system. FIG. 1 shows an example of the overall configuration of the distribution system of this embodiment. The distribution system of this embodiment consists of a distribution server 20. The distribution server 20 is communicatively connected to each of the venue terminal 11, online terminal 12, and distributor terminal 30 via a communication network. The communication network is, for example, the Internet, and is constructed by a public telephone line network, a cellular phone line network, a wireless communication channel, Ethernet (registered trademark), etc.

In this distribution system, live performances at a venue are recorded (which may include audio recording) and the video (which may include audio) is distributed online. The system assumes there are two types of viewers: those watching the live performance at the venue (hereinafter referred to as “venue viewers”) and those watching online (hereinafter referred to as “online viewers”). In this distribution system, when conducting questionnaires of viewers, for example to determine the next song to be performed or to change stage direction, the system collects responses from both venue viewers and online viewers.

The distribution server 20 may be a general-purpose computer, such as a workstation or personal computer, or it may be logically realized by cloud computing. The distribution server 20 can be, for example, a computer that provides video distribution services.

The venue terminal 11 and the online terminal 12 are computers operated by viewers. The venue terminal 11 and online terminal 12 are, for example, a smartphone, tablet computer, or personal computer. The venue terminal 11 is operated by the venue viewer and the online terminal 12 is operated by the online viewer. The venue terminal 11 and the online terminal 12, for example, have web browser functions and can communicate with the distribution server 20 using the HTTP protocol.

The distributor terminal 30 is a computer operated by the distributor of the video. The distributor terminal 30 is, for example, a personal computer or a smartphone. The distributor terminal 30 can, for example, upload video and audio of the performers' performances to the distribution server 20. The distributor terminal 30 may include both computers operated by performers and computers operated by distribution operators.

### <Configuration of Distribution Server 20>

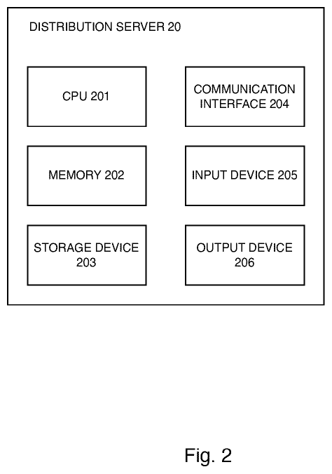

FIG. 2 shows an example of the hardware configuration of distribution server 20. The configuration shown in the figure is exemplary and may include other configurations. The distribution server 20 includes a CPU 201, memory 202, storage device 203, communication interface 204, input device 205, and output device 206. The storage device 203 is, for example, a hard disk drive, solid-state drive, or flash memory that stores various data and programs. The communication interface 204 is an interface for connecting to a communication network, and includes, for example, an adapter for connecting to Ethernet (registered trademark), a modem for connecting to a public telephone network, a wireless communication device for wireless communication, and USB (Universal Serial Bus) connectors and RS232C connectors for serial communication. The input device 205 is for inputting data and includes, for example, a keyboard, mouse, touch panel, buttons, and microphone. The output device 206 is for outputting data and includes, for example, a display, printer, and speakers. Each functional unit of distribution server 20 described later is implemented by CPU 201 reading and executing programs stored in storage device 203 into memory 202, and each storage unit of distribution server 20 is implemented as part of the storage area provided by memory 202 and storage device 203.

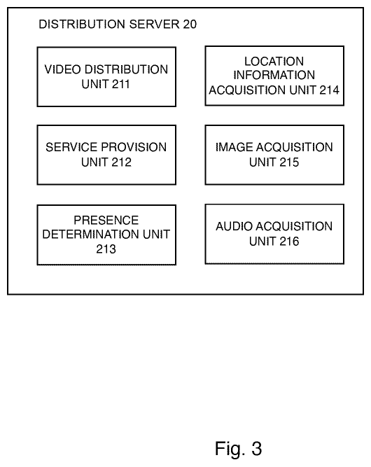

FIG. 3 shows an example of the software configuration of distribution server 20.

### ==Basic Configuration==

The distribution server 20 includes a video distribution unit 211, a service provision unit 212, a presence determination unit 213, a location information acquisition unit 214, an image acquisition unit 215, and an audio acquisition unit 216.

The video distribution unit 211 delivers video. The video distribution unit 211 can deliver video to online terminal 12 (first viewer terminal) of an online viewer (first viewer) who is watching the live video online.

The service provision unit 212 conducts questionnaires. The service provision unit 212 can accept responses to questionnaires from both online terminal 12 and venue terminal 11 (second viewer terminal) of venue viewers (second viewers) who are watching the live performance at the venue.

Therefore, the distribution system of this embodiment enables questionnaires to be conducted simultaneously both online and at the venue.

### ′==Questionnaire==

The service provision unit 212 can, for example, send a web page form screen to online terminal 12 and accept questionnaire responses as form data from online terminal 12.

While the service provision unit 212 may send surveys directly to venue terminal 11, in this embodiment the service provision unit 212 instead instructs distributor terminal 30 to conduct the survey. The survey questions can then be provided to venue viewers in one of two ways: either directly by the distributor, or by the performers following the distributor's instructions.

### ==Detection of Presence at the Venue==

The presence determination unit 213 determines whether the venue viewer is at the venue. The presence determination unit 213 can make this determination based on whether a designated WiFi device or other communication device installed at the venue can communicate with venue terminal 11. For example, the presence determination unit 213 can determine whether communication with venue terminal 11 is possible using only packets through the designated WiFi device.

Therefore, the distribution system of this embodiment can identify whether venue viewers are at the venue by utilizing communication devices such as WiFi equipment installed at the venue.

### ==Detection of Venue Presence Using Location Information==

The location information acquisition unit 214 acquires location information from venue terminal 11. The location information may be identified either by venue terminal 11 using GPS signals or by detecting whether venue terminal 11 can communicate with beacons installed at the venue.

The presence determination unit 213 can determine whether venue terminal 11 is at the venue based on this location information.

This enables the system to verify that a venue viewer (using venue terminal 11) is present at the venue through the use of location information.

### ==Detection of Venue Presence Using a Dedicated Application==

A link for downloading an application that runs on venue terminal 11 can be provided at the venue.

The presence determination unit 213 can determine whether the second viewer is at the venue based on whether communication with the application installed on venue terminal 11 is possible.

The presence of venue terminal 11 at the venue can be verified through the installation of the application that was downloaded and installed at the venue.

### ==Survey Responses via Application==

The service provision unit 212 can accept answers through operations on the application installed on venue terminal 11. In this case, the service provision unit 212 can receive the answers directly from the application.

### ==Survey Responses Using Viewers' Physical Actions==

Imaging devices such as cameras can be installed at the venue. The image acquisition unit 215 acquires image data of venue viewers captured by these devices at the venue. The image acquisition unit 215 can acquire the image data through communication with the imaging devices.

The service provision unit 212 can analyze the image data to extract at least one of the movements, postures, or actions of venue viewers, and can accept these as answers to the survey. For example, the service provision unit 212 can detect raised hands from the image data and count their number, that is, count the number of venue viewers who raised their hands at the venue, thereby obtaining aggregated survey results. The service provision unit 212 can also use the number of venue viewers standing or sitting at the venue as survey answers.

This enables venue viewers to provide survey answers through their body movements and postures.

### ==Survey Responses Using Device Lights==

The service provision unit 212 can analyze image data to detect illuminated lights on venue terminal 11 and accept the number of detected lights as answers to the survey from venue viewers. The lights can be activated either through the basic functions of venue terminal 11 by venue viewers, or through an application installed on venue terminal 11 that responds to venue viewer instructions.

This enables venue viewers to provide survey answers by turning on the lights of their venue terminals 11 such as smartphones.

### ==Survey Responses Using Audio Volume==

Sound collection devices such as microphones can be installed at the venue. The audio acquisition unit 216 can acquire audio data collected by these devices at the venue.

The service provision unit 212 can obtain the volume level of the audio data and accept it as a survey answer from venue viewers.

### ==Survey Responses Using Physical Buttons==

Buttons can be installed at the venue. The service provision unit 212 can obtain the number of pressed buttons as aggregated survey results.

### <Operation>

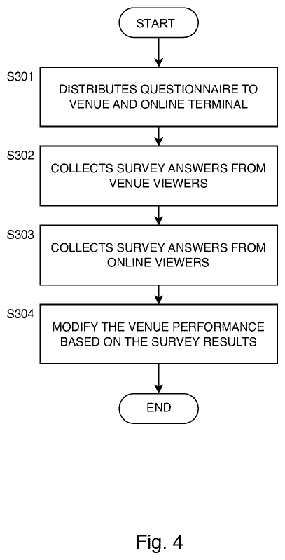

FIG. 4 illustrates the operation of the distribution system of this embodiment.

The distribution server 20 distributes questionnaire to both the venue and online terminal 12 (S301). For venue viewers, the distribution server 20 can either send questionnaire to venue terminal 11, or send them to distributor terminal 30 so that the questionnaire can be provided to venue viewers through video or audio by the distributor or by performers following the distributor's instructions. For online viewers, the distribution server 20 can send questionnaire to online terminal 12.

The distribution server 20 collects survey answers from venue viewers (S302). As described above, the distribution server 20 can receive answers from venue terminal 11, collect answers based on captured venue images, and collect answers based on audio collected at the venue.

The distribution server 20 collects survey answers from online viewers (S303). The distribution server 20 can receive answers from online terminal 12.

The distribution server 20 can modify the venue performance based on the survey results (S304). For example, it can change the next program or adjust stage lighting and visuals based on the results.

While the above describes embodiments of the present invention, these embodiments are presented to aid in understanding the invention and should not be construed as limiting its scope. The present invention can be modified and improved without departing from its spirit, and also includes equivalents thereof.

### DISCLOSURE

The present disclosure also includes the following configurations:

### [Item 1]

A distribution system comprising:
a video distribution unit that distributes live video to a first viewer terminal of a first viewer who is watching the video online; and
a service provision unit that accepts answers to the questions from both the first viewer terminal and a second viewer terminal of a second viewer who is watching the live performance at a venue.

### [Item 2]

The distribution system according to item 1, further comprising:
a presence determination unit that determines whether the second viewer is at the venue based on whether a communication device located at the venue can communicate with the second viewer terminal.

### [Item 3]

The distribution system according to item 1, further comprising:
a location information acquisition unit that acquires location information of the second viewer terminal from the second viewer terminal; and
a presence determination unit that determines whether the second viewer is at the venue based on the location information.

### [Item 4]

The distribution system according to item 1, wherein
a link for downloading an application that runs on the second viewer terminal is provided at the venue, and
the distribution system further comprising: a presence determination unit that determines whether the second viewer is at the venue based on whether communication with the application is possible.

### [Item 5]

The distribution system according to item 4, wherein
the service provision unit accepts the responses through operations on the application.

### [Item 6]

The distribution system according to any one of items 1 to 4, further comprising:
an image acquisition unit that acquires image data of the second viewer captured at the venue, wherein
the service provision unit analyzes the image data to extract at least one of movement, posture, or action of the second viewer and accepts the extracted at least one of movement, posture, or action as the answer.

### [Item 7]

The distribution system according to any one of items 1 to 4, further comprising:
an image acquisition unit that acquires image data of the second viewer captured at the venue, wherein
the service provision unit analyzes the image data and accepts, as the answer, a number of lights equipped on the second viewer terminal that are illuminated.

### [Item 8]

The distribution system according to any one of items 1 to 4, further comprising:
an audio acquisition unit that acquires audio data collected at the venue, wherein
the service provision unit accepts, as the answer, a volume of the audio data.

### REFERENCE SIGNS LIST

11 venue terminal
12 online terminal
20 distribution server
30 distributor terminal

1. A distribution system comprising:
a video distribution unit that distributes live video to a first viewer terminal of a first viewer who is watching the video online; and
a service provision unit that accepts answers to the questions from both the first viewer terminal and a second viewer terminal of a second viewer who is watching the live performance at a venue.

2. The distribution system according to claim 1, further comprising:
a presence determination unit that determines whether the second viewer is at the venue based on whether a communication device located at the venue can communicate with the second viewer terminal.

3. The distribution system according to claim 1, further comprising:
a location information acquisition unit that acquires location information of the second viewer terminal from the second viewer terminal; and
a presence determination unit that determines whether the second viewer is at the venue based on the location information.

4. The distribution system according to claim 1, wherein
a link for downloading an application that runs on the second viewer terminal is provided at the venue, and
the distribution system further comprising: a presence determination unit that determines whether the second viewer is at the venue based on whether communication with the application is possible.

5. The distribution system according to claim 4, wherein
the service provision unit accepts the responses through operations on the application.

6. The distribution system according to claim 1, further comprising:
an image acquisition unit that acquires image data of the second viewer captured at the venue, wherein
the service provision unit analyzes the image data to extract at least one of movement, posture, or action of the second viewer and accepts the extracted at least one of movement, posture, or action as the answer.

7. The distribution system according to claim 1, further comprising:
an image acquisition unit that acquires image data of the second viewer captured at the venue, wherein
the service provision unit analyzes the image data and accepts, as the answer, a number of lights equipped on the second viewer terminal that are illuminated.

8. The distribution system according to claim 1, further comprising:
an audio acquisition unit that acquires audio data collected at the venue, wherein
the service provision unit accepts, as the answer, a volume of the audio data.
